(19) United States
(12) Patent Application Publication
(10) Pub. No.: US 2011/0310244 A1
(43) Pub. Date: Dec. 22, 2011

(54) SYSTEM AND METHOD FOR DETECTING A DEFECT OF A SUBSTRATE

(75) Inventors: Jean-Philippe Schweitzer, Shanghai (CN); Huifen Li, Shanghai (CN); Xiaofeng Lin, Shanghai (CN); Feng Guo, Shanghai (CN); Xiaofeng Guo, Shanghai (CN)

(73) Assignee: SAINT-GOBAIN GLASS FRANCE, Courbevoie (FR)

(21) Appl. No.: 13/203,526

(22) PCT Filed: Feb. 26, 2010
(86) PCT No.: PCT/CN10/70790

§ 371 Date: Aug. 26, 2011

(30) Foreign Application Priority Data
Feb. 27, 2009 (CN) 200910117993.X
Jun. 22, 2009 (CN) 200910150940.8

(51) Int. Cl. H04N 7/18

(52) U.S. Cl. 348/92; 348/E07.085

(57) ABSTRACT

A system and a method for detecting defects of a substrate are provided. The system includes: a first illuminating component, disposed at one side of the substrate and adapted to emit diffused light to the substrate; a first imaging component, disposed at the other side of the substrate and adapted to scan the substrate by sensing light emitted by the first illuminating component and transmitted through the substrate, the first illuminating component and the first imaging component constructing a first detection channel; and a transport module, adapted to produce relative motion between the substrate, and the first illuminating component and the first imaging component.

The present application claims priorities of Chinese patent application No. 200910117993.X filed on Feb. 27, 2009 and Chinese patent application No. 200910150940.8 filed on Jun. 22, 2009. All the contents of the two Chinese patent applications are incorporated herein by reference.

### FIELD OF THE INVENTION

The present invention relates generally to a method and system for detecting a defect of a substrate, and, more specifically, to a method and system for detecting a defect on or in a transparent or semi-transparent and patterned or structured substrate.

### BACKGROUND OF THE INVENTION

In the field of transparent or semi-transparent substrate, the patterned or structured substrate becomes more and more popular as increased demands of improved functions like in solar module industry. Defect detection of products is an important tool for quality control. For instance, various types of defects may be formed by different reasons during the process of glass manufacture, including surface defects such as scratches, stains, and open bubbles, and internal defects such as close bubbles, white, black or other colour inclusions. Tasks of defect detection are not only to detect defects but also to classify these defects since specifications of quality control are different for different types of defects.

Challenge of detecting defects of a patterned or structured substrate is to remove strong influence of patterns or structures on the substrate to detected images which influence results in difficulties in detecting accurately defects. In non-diffusive illumination mode, lights enter the substrate at angles within a certain range. Light intensity of incident lights is modulated by regular patterns or structures on the substrate so that obvious alternating bright and dark patterns occur in raw images collected by image sensor. FIG. 1A shows raw images collected by image sensor in non-diffusive transmitting illumination mode. As seen from FIG. 1A, strong influence of patterns to images results in difficulty in detecting defects and further dimensioning and classifying the defects. For example, entire image of a defect with small size may be covered under image of a pattern, thereby it is difficult even impossible to detect such defects; part of image of a large-size defect formed between two patterns will be covered by images of patterns. Thus, even if such defect is detected, it is difficult to calculate its real size.

Patent application CN1908638 published on Feb. 7, 2007 discloses an optical method and apparatus for detecting defects of patterned glass as an example of such patterned or structured substrate, where an Edge Lighting (EL) mode is used, as shown in FIG. 1B. It is disclosed that laser light beam is extended with a cylindrical lens to enter one side of the glass under detection. The incident light travels in parallel to glass surface. The light is scattered by the defects in the glass and the scattered light is collected by an image sensor disposed above or under the glass surface, so that a raw image can be obtained. Although such edge lighting mode weakens influence of patterns to the raw image, defects such as dark inclusions are undetectable. In addition, such lighting mode only can be used to detect a small-size substrate, because the cylindrical lens is difficult to be made long with high-quality so that laser beam can be extended to be of limited width. Furthermore, the light energy will attenuated sharply in the glass in width, thus the edge or even the center of the glass under detection may not be illuminated with strong light enough to obtain clear raw image. In case of large glass under detection, a reduced precision will be a result.

Therefore, it is desirable to provide a method and system capable of detecting with high resolution various a defect on or in transparent or semi-transparent patterned substrate regardless of size thereof Further, it is desirable to provide a method and system capable of classifying with high precision the defected defect on or in the patterned substrate.

### SUMMARY OF THE INVENTION

An object of the present invention is to provide a method and system for accurately detecting a defect on or in a transparent or semi-transparent patterned or structured substrate. Another object of the present invention is to provide a method and system for classifying the detected defect.

A system for detecting a defect of a transparent or semi-transparent substrate according to the present invent is provided, which comprises: a first illumination component, disposed at one side of the substrate and adapted to emit a diffusive light to the substrate; a first imaging component, disposed at opposite side of the substrate and adapted to scan the substrate by sensing light emitted by the first illumination component and transmitted through the substrate, the first illumination component and the first imaging component constructing a first detection channel; and, a transport module, adapted to produce relative motion between the substrate, and the first illumination component and the first imaging component.

A system for detecting a defect of a transparent or semi-transparent substrate according to the present invention, which comprises: a second illumination component, disposed at one side of the substrate or opposite side of the substrate and adapted to emit a light to the substrate; a second imaging component, disposed at the opposite side of the substrate and adapted to scan the substrate by sensing light derived from scattering through the substrate of the light emitted by the second illumination component; and, a transport module, adapted to produce relative motion between the substrate, and the second illumination component and the second imaging component, wherein the second illumination component and the second imaging component construct a second detection channel.

A system for detecting a defect of a transparent or semi-transparent substrate according to the present invention, which comprises: a third illumination component, adapted to emit a light to the substrate; a third imaging component, disposed at one side of the substrate and adapted to scan the substrate when the third illumination component emits the light to the substrate; a first polarization component, having a first polarization direction and arranged between the third illumination component and the substrate; a second polarization component, having a second polarization direction orthogonal to the first polarization direction and arranged between the third imaging component and the substrate; and, a transport module, adapted to produce relative motion between the substrate, and the third illumination component, the first polarization component, the second polarization component and the third imaging component, wherein the third illumination component, the first polarization component, the second polarization component and the third imaging component construct a third detection channel.

A method for detecting a defect of a transparent or semi-transparent substrate according to the present invention is provided, which comprises: using a first illumination component disposed at one side of the substrate to emit a diffusive light to the substrate; using a first imaging component disposed at opposite side of the substrate to scan the substrate by sensing light emitted by the first illumination component and transmitted through the substrate, the first illumination component and the first imaging component constructing a first detection channel; producing relative motion between the substrate, and the first illumination component and the first imaging component; and, processing data from the first imaging component, to detect and classify the defect of the substrate.

A method for detecting a defect of a transparent or semi-transparent substrate according to the present invention is provided, which comprises: using a second illumination component disposed at one side or opposite side of the substrate to emit a light to the substrate; using a second imaging component disposed at the opposite side of the substrate and adapted to scan the substrate by sensing light derived from scattering through the substrate of the light emitted by the second illumination component; producing relative motion between the substrate, and the second illumination component and the second imaging component; and, processing data from the second imaging component, to detect and classify the defect of the substrate.

A method for detecting a defect of a transparent or semi-transparent substrate according to the present invention, which comprises: using a third illumination component to emit a light to the substrate; using a third imaging component disposed at one side of the substrate to scan the substrate when the third illumination component emits the light to the substrate; arranging a first polarization component having a first polarization direction between the third illumination component and the substrate; arranging a second polarization component having a second polarization direction orthogonal to the first polarization direction between the third imaging component and the substrate; producing relative motion between the substrate, and the third illumination component, the first polarization component, the second polarization component and the third imaging component; and, processing data from the third imaging component, to detect and classify the defect of the substrate.

### BRIEF DESCRIPTION OF THE DRAWINGS

The above and the other features of the present invention will be understood better from the following detailed description of exemplified embodiments of the present invention with reference to the accompanying drawings.

FIG. 1A shows defects appearing in the image taken by using the illumination mode in defect detection method of the prior art;

FIG. 1B is schematic diagram showing an apparatus that performs detection by using Edge Lighting mode according to the prior art;

FIG. 2 is a schematic view illustrating a system for detecting a defect on or in a substrate according to a first embodiment of the present invention;

FIG. 3 is a schematic view illustrating a single-channel optical configuration according to the first embodiment of the present invention;

FIG. 4 is a view showing raw images obtained by the single-channel detection system according to the first embodiment of the present invention;

FIG. 5 is a schematic view illustrating a two-channel optical configuration according to a second embodiment of the present invention;

FIG. 6 is a time chart showing trigger timings of each of components in the two-channel optical configuration according to the second embodiment of the present invention;

FIG. 7 is a view showing raw images obtained by the two-channel detection system according to the second embodiment of the present invention;

FIG. 8 is a schematic view illustrating a three-channel optical configuration according to a third embodiment of the present invention;

FIG. 9 is a time chart showing trigger timings of each of components in the three-channel optical configuration according to the third embodiment of the present invention; and

FIG. 10 is view showing raw images obtained by a first detection channel and a third detection channel in the three-channel optical configuration according to the third embodiment of the present invention.

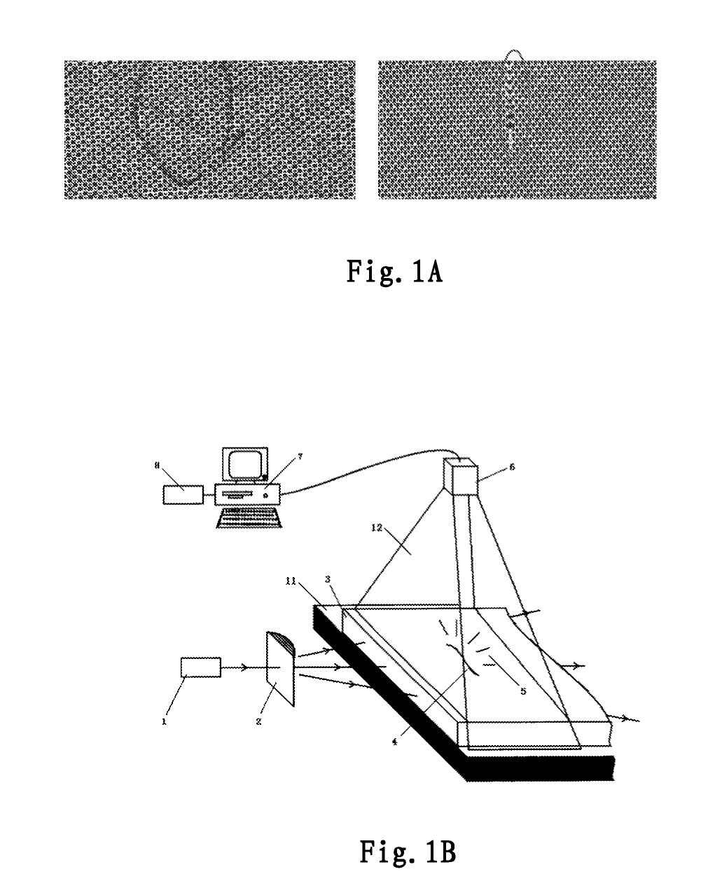

### MODES FOR CARRYING OUT THE PRESENT INVENTION

It is to be understood that the figures and descriptions of the present invention may have been simplified to illustrate elements that are relevant for a clear understanding of the present invention, while eliminating, for purposes of clarity, other elements found in a typical defect detection system. Those of ordinary skilled in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

Below, embodiments of the present invention will be explained in details in conjunction with the drawings.

### First Embodiment

As stated above, the key to detect local defects in a patterned or structured substrate is to remove the influence of pattern or structure and highlight the defects from background. Close and diffusive illumination of the substrate proposed in the first embodiment of the present invention solves the above-mentioned problem. As stated above, in other illumination modes, incident light enters the substrate in a certain angle range. Due to regular shape of pattern of the substrate, modulation of incident light in a certain angle range by these patterns causes alternating of bright and dark patterns in raw images collected by an image sensor. In contrast, in diffusive illumination mode of the present invention, ideally, if the incident light of a diffusive light source is any directional, each region of the substrate would be illuminated by light at each angle over entire space. Although, in practice, the incident angle of diffusive light source is limited, and absolutely uniform light distribution on the substrate is impossible, light rays emitted by a diffusive light source when being located very close to the substrate have a relatively uniform distribution over an enough wide region. Uniform illumination weakens modulation of pattern or structure of the substrate significantly, thereby highlighting defects from background. That is to say, a diffusive illumination source is disposed relative to the substrate in a way of providing substantially uniform illumination.

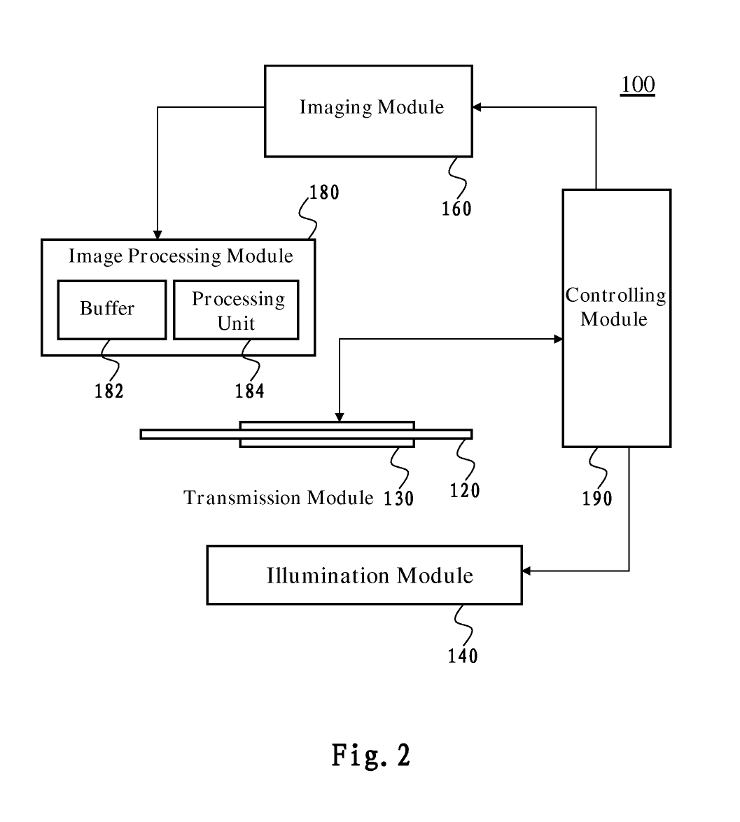

FIG. 2 shows a system 100 for detecting a defect on or in a substrate 120 according to the first embodiment of the present invention. The defect detection system 100 comprises a transport module 130, an illumination module 140, an imaging module 160, an image processing module 180 and a controlling module 190. In order to remove the influence of environment light, the whole system is preferably closed with a black cover (not shown in FIG. 2).

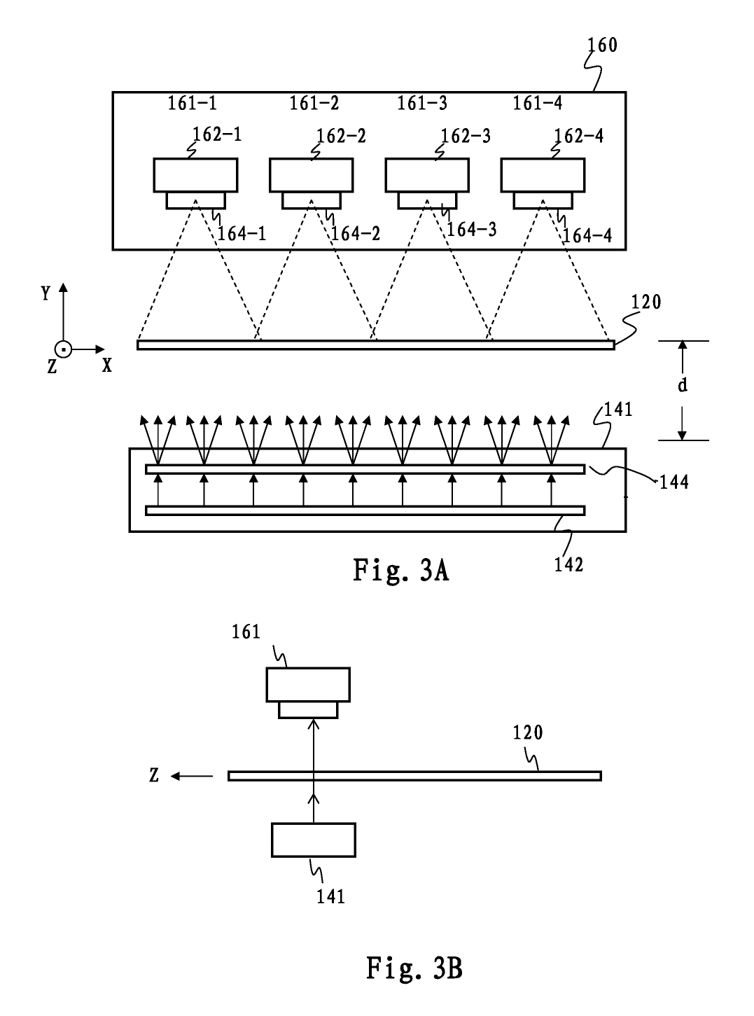

In the present embodiment, the substrate 120 may be patterned or structured glass, plastic, or any other transparent or semi-transparent material such as a patterned substrate used in a photovoltaic cell or a photovoltaic module, and is not limited to the form of a sheet having substantially parallel surfaces, but can be extended to the form of a cylinder curved in a plane vertical to transporting direction of the substrate. Unless otherwise specified, as used therein, the term “two opposite sides of the substrate” refers to two sides along a normal to surface of the substrate, i.e. two sides above and under the substrate 120 as illustrated in FIG. 3.

The transport module 130 is used to produce relative motion between the transparent substrate 120, and the imaging module 160 and the illumination module 140. For example, as shown in FIG. 2, the relative motion may be developed by moving the substrate 120 in a direction normal to the plane of FIG. 2 relative to the imaging module 160 and the illumination module 140. Alternatively, the relative motion may be developed by moving the illumination module 140 and the imaging module 160 relative to the substrate 120. For example, for the big-scale substrate, moving the illumination module 140 and the imaging module 160 may become an attractive alternative to moving the substrate 120. However, alignment of the optics in case that the substrate is moved is easier than that in case that illumination module and imaging module are moved. The transport module 130 in the present embodiment may comprise, for example, a linear stage, stepper motors, conveyor belts, tracks, carriages, pneumatic tables, air bearings, or other conventional methods of conveying either a substrate, camera and/or light sources. For purposes of illustration and not limitation, it will be hereinafter assumed that the substrate 120 is moved relative to the illumination module 140 and the imaging module 160. The transport module 130 preferably comprises an adjusting component for moving the substrate 120 in a direction of surface normal of the substrate 120, as indicated by Y direction in FIG. 3, to maintain a consistent distance between the substrate 120, and the illumination module 140 and the imaging module 160. Further, the transport module 130 may also perform a flattening function to minimize errors due to flattering of the substrate 120 during scanning. Flattening may be performed in a conventional manner, such as using air pressure (e.g. air bearings).

FIG. 3A and FIG. 3B, in front view and in side view respectively, illustrate the illumination module 140 and the imaging module 160 in the defect detection system 100 shown in FIG. 2 as well as position relationship between the two modules and the substrate 120. As illustrated in FIGS. 3A and 3B, in the defect detection system 100, the substrate 120 moves in Z direction. The imaging module 160 comprises a first, second, third and forth imaging component 161-1, 161-2, 161-3 and 161-4 disposed above the substrate 120, each of which imaging components comprises an image sensor 162 (indicated as 162-1, 162-2, 162-3, and 162-4 in FIGS. 3A and 3B) and one or more imaging lenses 164 (indicated as lenses 164-1, 164-2, 164-3, and 164-4 in FIGS. 3A and 3B). In the present disclosure, unless otherwise specified, so-called imaging component 161 refers collectively to all of four imaging components 161-1, 161-2, 161-3 and 161-4 shown in FIGS. 3A and 3B, the so-called image sensor 162 refers collectively to all of the four image sensors 162-1, 162-2, 162-3, and 162-4 shown in FIGS. 3A and 3B, and the so-called imaging lens 164 refers collectively to all of the four imaging lenses 164-1, 164-2, 164-3, and 164-4 shown in FIGS. 3A and 3B.

The imaging lens 164 is used for collecting light and imaging the light onto the photosensitive plane of the image sensor 162. The imaging component 161 has a numerical aperture defining the acceptance angle over which an imaging component is capable of receiving light, and is largely controlled by the imaging lens 164 and any other aperture-limiting elements included in the imaging component, such as iris. The image sensor 162 is used to sense light imaged on photosensitive planes thereof and converting the light into an electrical signal. In the embodiment of the present invention, the image sensor 162 is line scanning camera, such as CCD line scanning sensor, CMOS line scanning sensor, or any other sensor type capable of converting light into an electrical signal. Line scanning cameras are readily commercially available and may be used to scan the substrate 120 one scan at a time at a rate of several hundred or even several hundred of hundreds scans per second. Scanning lines of the first, second, third and forth imaging component 161-1, 161-2, 161-3, and 161-4 on the substrate 120 are substantially parallel and typically normal to the moving direction of the substrate 120. The imaging component 161 focuses on the illuminated portion of the surface on the substrate 120. It is should be noted that, in practice, the focus lines on the surface of the substrate 120 of the four imaging components 161-1, 161-2, 161-3, and 161-4 do not necessarily coincide with each other strictly, particularly in case of low real-time detection performance requirement. It should be noted that number of imaging components 161 is not limited to four as described above, but may be set to be less than 3 (even, 1) or more than 5 depending on width of the substrate, numerical aperture of imaging component, detection precision, as well as estimated maximum number or minimum detection size of defects on the substrate, etc.

As illustrated in FIG. 3, in the present embodiment, the illumination module 140 comprises a diffusive illumination component 141 disposed under the substrate 120 in a manner such that the illumination component 141 is parallel with the width direction, i.e. X direction in FIG. 3A, of the substrate 120. The diffusive illumination component 141 comprises a first light source 142 and a diffuser 144 placed between the first light source 142 and the substrate 120. Light emitted by the first light source 142 becomes diffusive light through the diffuser 144, thereby illuminating the substrate 120 in a diffusive illumination mode. At least a portion of light projected on the substrate 120 from the diffusive illumination component 141 is transmit through the substrate 120 and sensed simultaneously by four imaging components 161-1, 161-2, 161-3, and 161-4, thereby providing bright field illumination of the substrate 120 relative to the imaging components 161-1, 161-2, 161-3, and 161-4 via transmission path.

It should be noted that, in the present embodiment, the first light source 142 may be semiconductor light sources, such as LED (light emit diode) or LD (laser diode), fluorescent lights, and halogen lights. Further, in the present embodiment, light sources may be of any spectral range as long as the image sensors 162 may be photosensitive to light emitted by the light sources. Further, in the present embodiment, light sources are not limited to monochromatic ones. Polychromatic light source having a wide spectral range is possible, such as a white light source. In addition, a diffusive light source may be easily made a large size; for example, a LED array of several meter length may be commercially available. Thus, the defect detection technology of the present embodiment may be applied to such substrates as ones of great width. In the present embodiment, length of the first light source 142 and the diffuser 144 is equal to or slightly larger than the width of the substrate 120 in X direction.

Although in the present embodiment a single long diffusive light source is used as a first light source 142 and is aligned in Z direction to the linearly disposed four imaging component 161-1, 161-2, 161-3, and 161-4, a plurality of short diffusive light source may be used to illuminate the substrate 120 in the present embodiment. For example, four diffusive illumination component 141-1, 141-2, 141-3, and 141-4 which are aligned in Z direction to the four imaging component 161-1, 161-2, 161-3, and 161-4 respectively may be used. Further, the plurality of illumination components may be placed in a line in X direction (similar to the case of using a single long diffusive light source), or may be spaced each other in Z direction but being aligned to the respective imaging components. In the latter case, the four imaging components and respective diffusive illumination components operate at positions of different Z values on the substrate at the same time. Exact positions of defects on the substrate may be determined by subsequent image processing in consideration of distances between the diffusive illumination components.

Preferably, in the present embodiment, for purpose of providing as uniform as possible illumination of the substrate 120, the diffusive illumination module 141 is disposed very close to the substrate 120. The experimental results demonstrate that the closer between the diffusive illumination module 141 and the substrate 120 are, the better influence of the patterns is removed and the higher detection precision is.

Referring back to FIG. 2, the imaging module 160 sends a plurality of sensed images to the image processing module 180 which in turn store and assemble the images. As shown in FIG. 2, the image processing module 180 preferably comprises a data buffer 182 (memory 182) and a processing unit (e.g. computer) 184 for processing data from the imaging module 160. The controlling module 190 acts as an external trigger for controlling trigger timing of each of illumination components and imaging components. The controlling module 190 may be any type of pulse trigger, such as but not limited to an encoder.

The operation of defect detection system 100 in FIG. 2 may proceed in the following manner. The controlling module 190 is used to control work timing of each of the diffusive illumination components 141 and the imaging components 161-1, 161-2, 161-3, and 161-4, so that as the substrate 120 is moved past the illumination module 140 and the imaging module 160, the first light source 142 of the diffusive illumination component 141 is switched on, while the four imaging components 161-1, 161-2, 161-3 and 161-4 begin to simultaneously capture light transmit through the substrate 120. The imaging components 161 send obtained data to the image processing module 180. The imaging processing module 180 then stores received data from each of imaging components in an array for respective imaging component in the buffer 182. The processing unit 184 of the image processing module 180 performs characterizing calculations necessary to identify and categorize defects on or in the substrate 120. Detection results are displayed to the operator for quality control. Rate of image capturing and processing should correspond to movement speed of the substrate 120. In practice, a standard piece may be used to calibrate the defect detection system 100.

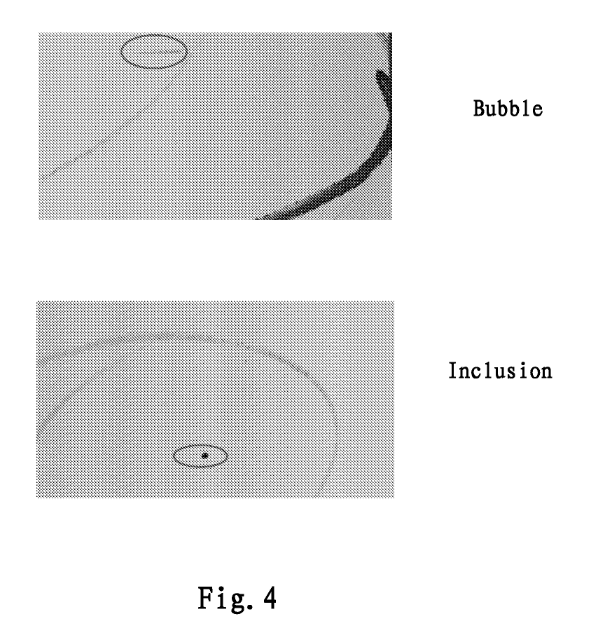

FIG. 4 shows detection results of defects in patterned glass such as bubbles and inclusions, which are shown in elliptical boxes, by the defect detection system 100 of FIG. 3. As seen from FIG. 4, because the illumination is wide and very close to the substrate under detection, the light can transmit the pattern or structure on the substrate nearly in any angle. Thus, bright and uniform background is generated in the collected raw image. Therefore, the defect detection system 100 of the present embodiment is capable of accurately identify and pre-categorize various defects as described above.

In the embodiment shown in FIG. 3, only a bright field transmission channel constructed by the diffusive illumination component 141 and imaging component 161 is used, which channel is hereinafter referred to a first channel or a first detection channel. However, in first channel, since grayscale characterizes of defects in obtained raw images are weakened due to diffusive illumination, distinguishing the same kind of local defects which exist in the different position of substrate in thickness direction is made difficult, such as open bubbles formed on the surface of the substrate from close bubbles formed in the substrate.

### Second Embodiment

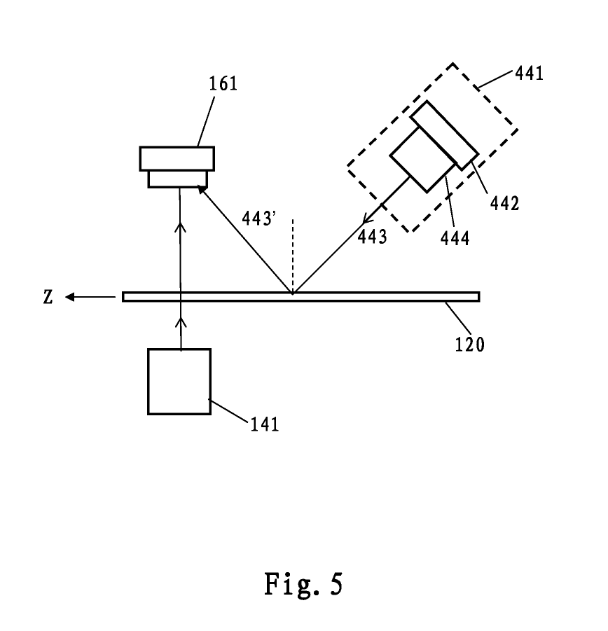

FIG. 5 illustrates a two-channel optical configuration according to a second embodiment of the present invention, for enhancing the classification reliability of defects identified by the first detection channel. In the illustrated two-channel configuration, a collimated illumination component 441 is added to illumination module 140 compared to configuration illustrated in FIG. 3. Elements in FIG. 5 are denoted by similar reference signs with similar elements in FIG. 3.

The collimated illumination component 441 comprises a second light source 442 and a collimation optical element 444 (for example, one or more lenses). The light emitted by the second light source 442 becomes collimated light through the collimation optical element 444 and then impinges onto the substrate 120 in the direction indicated by Arrow 443. The collimated illumination component 441 is disposed such that the second light source 442 provides dark field illumination of substrate 120 relative to the four imaging components 161-1, 161-2, 161-3 and 161-4. As shown in FIG. 5, the collimated illumination component 441 is located on the same side of the substrate 120 as the four imaging components 161-1, 161-2, 161-3 and 161-4 (they are both located above the substrate 120 in FIG. 5, but one skilled in the art should contemplate that they can be located under the substrate 120 correspondingly). At lease a portion of light from the collimated illumination component 441 is reflected from the substrate 120 in a direction indicated by Arrow 443′, and then sensed by the four imaging components 161-1, 161-2, 161-3 and 161-4, thereby providing a dark field illumination of the substrate 120 relative to the four imaging components via a reflection path. Hereinafter, the dark field reflection detection channel constructed by the collimated illumination component 441 and the four imaging components 161-1, 161-2, 161-3 and 161-4 is also referred to a second detection channel or a second channel. In two-channel optical configuration illustrated in FIG. 5, the first light source 142 and the second light source 442 may be, for example, LED (light emit diode) or LD (laser diode). Similarly, two light sources may be of any spectral range as long as image sensors 162 may be photosensitive to light emitted by the light sources. Further, two light sources are not limited to monochromatic ones. Polychromatic light source having a wide spectral range is possible, such as a white light source. Those skilled in the art will understand that if the second detection channel is used alone, the second light source 442 may also be a halogen lamp or a fluorescent lamp.

In the present embodiment, the two illumination components, the collimated illumination component 441 and the diffusive illumination component 141, are not switched on simultaneously, but used to illuminate the substrate 120 alternately. The four imaging components 161-1, 161-2, 161-3 and 161-4 work both when the collimated illumination component 441 switches on and when the diffusive illumination component 141 switches on. Therefore, the operation of the defect detection system of the two-channel configuration in FIG. 5 may proceed in the following manner, using the controlling module 190 to control work timing of each of the collimated illumination component 441, the diffusive illumination component 141, and the four imaging components 161-1, 161-2, 161-3 and 161-4. As the substrate 120 is moved past the illumination module 140 and the imaging module 160, the first light source 142 of the diffusive illumination component 141 is switched on, while the four imaging components 161-1, 161-2, 161-3 and 161-4 begin to capture light transmit through the substrate 120, thereby performing first channel detection. Then, the first light source 142 of the diffusive illumination component 141 is switched off, and the second light source 442 of the collimated illumination component 441 is switched on while the four imaging components 161-1, 161-2, 161-3 and 161-4 begin to capture light reflected from the substrate 120, thereby performing the second channel detection.

Specifically, the controlling module 190 is used to sense displacement of the substrate 120 and calculate a period over which the substrate 120 moves a certain displacement

$$Δ L = \frac{P}{M}$$

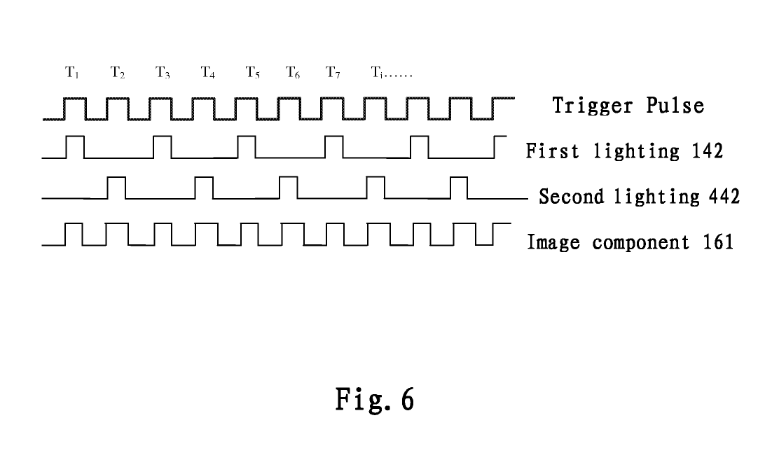

as a working period, where P denotes pixel width of image sensor in imaging component, and M denotes imaging magnification of the image sensor. All of channel detections should be performed in one working period. The controlling module 190 then divides one working period into n equal or unequal parts based on number of groups n (n is a positive integral which is 2 or more) of detection channels which do not work simultaneously, resulting in trigger pulse sequence Tᵢ (i is a positive integral) shown in FIG. 6. Specifically, in three-channel configuration of the present embodiment, since the first channel detection and then the second channel detections are performed in one working period ΔT, one working period AT comprises two trigger pulses, such as T₁ and T₂. The controlling module 190 also controls operations of each of imaging components so as to scan the illuminated substrate when illumination from the light source is stable. It is noted that durations of n pulses included in one working period may be equal or unequal. For example, in order to improve signal-to-noise ratio of data obtained from reflection channels, the durations of reflection channels may be set to be longer than those of transmission channels.

Now controlling operation of the controlling module 190 with respect to each of light sources and imaging components is described referring to trigger pulse sequences shown in FIG. 6. During T₁ pulse period, after a certain delay of leading edge of pulse 1 generated by the controlling module 190, the first light source 142 switches on and illuminates the substrate 120 for a certain pulse width (which is less than a pulse period). The four image sensors 162-1, 162-2, 162-3, and 162-4 of the four imaging components 161-1, 161-2, 161-3 and 161-4 begin to work after the first light source 142 switches on. The first light source 142 then switches off before leading edge of pulse 2 comes while the four image sensors 162-1, 162-2, 162-3, and 162-4 are closed. During period of the first light source 142 being on, the second light source 442 keeps off, and the four imaging components 162 capture light transmit through the substrate 120 and send obtained data to the image processing module 180. The imaging processing module 180 then stores received data from each of the imaging sensors 162-1, 162-2, 162-3, and 162-4 in an array for respective imaging sensor in the buffer 182.

After a certain delay of leading edge of pulse 2, the second light source 442 switches on and illuminates the substrate 120 for a certain pulse width. The four image sensors 162 begin to work after the second light source 442 switches on. The second light source 442 then switches off before leading edge of pulse 3 comes while the four image sensors 162 are closed. During period of the second light source 442 being on, the first light source 142 keeps off, and the four imaging components 161 capture light reflected from the substrate 120, and send obtained data to the image processing module 180. The imaging processing module 180 then stores data received from each of the imaging sensors 162-1, 162-2, 162-3, and 162-4 in an array for respective imaging sensor in the buffer 182.

Similarly, during odd-numbered pulse period T₂ⱼ₋₁ (j is a positive integral), the first light source 142 works, and data obtained from the first detection channel is stored in the buffer 182 of the image processing module 180; while during even-numbered pulse period T₂ⱼ, the second light source 442 works, and data obtained from the second detection channel is stored in the buffer 182.

It should be noted that a plurality of imaging components of the present embodiment is not limited to the illustrated case in which all of imaging components capture images when the collimated illumination component 441 switches on, but may be extended to the case in which one or more among said plurality of imaging components work(s) when the collimated illumination component 441 switches on based on analysis results of raw images obtained from the first detection channel. For example, if a defect of bubble type in imaging region of the third imaging component 161-3 in raw images obtained from the first detection channel cannot be determined to be open bubble or close bubble, the controlling module 190 performs controlling so that only the third imaging component 161-3 is triggered to capture images when the collimated illumination component 441 switches on. In addition, although the first channel and the second channel share the imaging components 161, the present invention is not limited thereto, but one or more imaging components other than the imaging components 161 in the first channel are provided for the second channel.

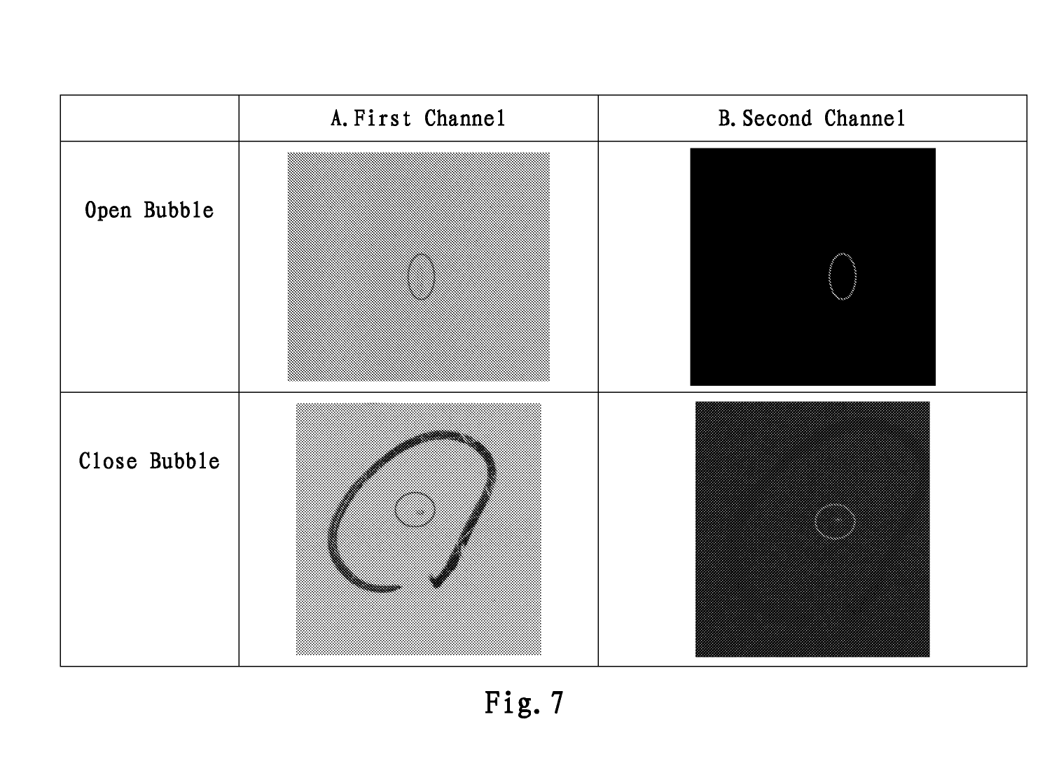

FIG. 7 illustrates detection results of open bubbles and close bubbles on or in patterned glass by the two-channel optical configuration illustrated in FIG. 5. As shown in “First Channel” in FIG. 7, either an open bubble or a close bubble appears black elliptical in raw images obtained by the single channel optical configuration in FIG. 3, thereby can not be distinguished from each other. In contrast, in case of addition of the second channel, as shown in “Second Channel” in FIG. 7, an open bubble cannot be detectable in raw image obtained by the second channel, while a close bubble appears bright in raw image obtained by the second channel as shown in an elliptical box, thereby clearly distinguishing surface defect from internal defect.

Further, although the second detection channel is described to be of a dark field reflection mode in above embodiment, those skilled in the art may contemplate the second detection channel of dark field transmission mode by placing the light sources relative to the imaging components. I.e., in the second detection channel, the illumination component 441 and the imaging component 161 may also be set at two sides of the substrate 120 respectively, and the imaging component 161 scans the substrate 120 by sensing the light derived from scattering through the substrate 120 of the light emitted by the illumination component 441.

Those skilled in the art will understand that in the second embodiment, the angle at which the collimated illumination component 441 emits light is set such that in images that are formed by the imaging components 161 based on light derived from that the substrate 120 scatters the light emitted by the collimated illumination component 441, the open bubble of the substrate 120 is not visible and the close bubble of the substrate 120 is visible, but the present invention is not so limited. In other some embodiments of the present invention, the collimated illumination component 441 may also be set such that in the images that are formed by the imaging components 161 based on the light derived from that the substrate 120 scatters the light emitted by the collimated illumination component 441, the open bubble of the substrate 120 is visible and the close bubble of the substrate 120 is not visible.

Those skilled in the art will understand that in the second embodiment and modifications thereof, the collimated illumination component 441 is set such that in the images that are formed by the imaging components 161 based on the light derived from that the substrate 120 scatters the light emitted by the collimated illumination component 441, one of the open bubble and the close bubble of the substrate 120 is visible and the other is not visible, but the present invention is not so limited. In other some embodiments of the present invention, an illumination component with a radiation angle may also be used, so that in the images that are formed by the imaging components 161 based on the light derived from that the substrate 120 scatters the light emitted by the illumination component with the radiation angle, the open bubble and the close bubble of the substrate 120 are visible. Under the condition that the open bubble and the close bubble of the substrate 120 are visible, lightness and other features (e.g., roughness) may be used to determine that a defect appearing the images is the open bubble or the close bubble of the substrate 120.

### Third Embodiment

Even if the substrate is subjected to washing process prior to inspection of defects, there are still foreign bodies such as dusts on surfaces of the substrate. Those foreign bodies such as dusts on surfaces of the substrate may result in misclassification of the defects detection system as real defects. It will undoubtedly increase fake defects rate of inspection (i.e. the probability of categorizing fake defects as real defects) and consequently increase waste of qualified product. In order to removing influences of the dusts and to further accurately identify inclusions, bubbles and other stress or optical-distortion type defects, a third embodiment of the present invention provides a solution for detecting stress or optical-distortion type defects of the substrate based on change of polarization characteristic of detection light resulting from presence of the defects. When the substrate is illuminated by a linear-polarization light, if the substrate is of uniform optical characteristic, i.e. no stress or optical-distortion type defects, light transmit through the substrate has substantially uniform polarization characteristic. At this point, an image with total extinction may be obtained by use of a polarizer disposed before the imaging component and of a polarization direction orthogonal to that of the linear-polarization light. While, if there are stress or optical-distortion type defects in an area of the substrate, the polarization characteristic of light transmit through the area is different from that of light transmit through other areas. As a result, a total extinction would not be seen with respect to the light transmit through the area having stress or optical-distortion type defects. In other words, in the image of the substrate captured by the imaging component, areas having the type of defects appear as bright areas while the surrounding areas thereof appear as dark background.

As used therein, the term “stress type of defects” means defects which result in local stress in the substrate. The present inventors demonstrate experimentally that the inclusions (white, black or other color inclusions) or recrystallization will result in stress in the substrate. As used therein, the term “optical-distortion type of defects” means defects whose presence result in changes of propagation direction of light, such as knots.

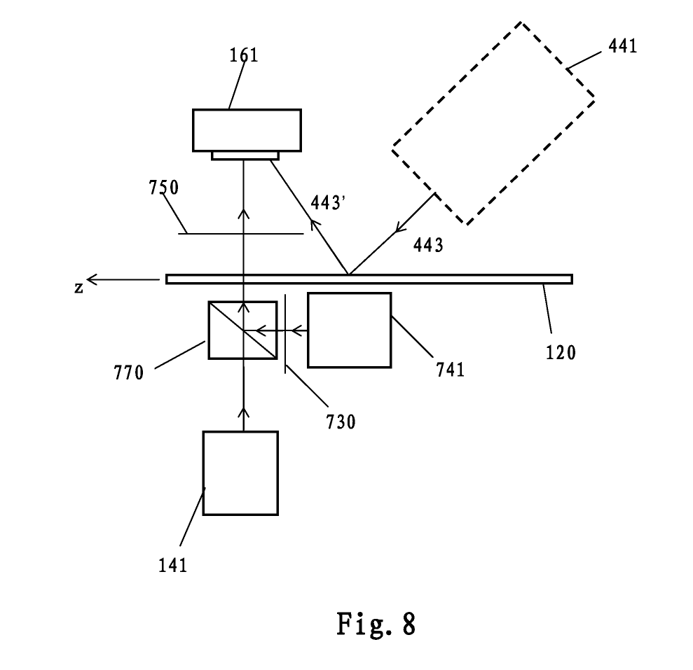

FIG. 8 shows a three-channel optical detection configuration according to the third embodiment of the present invention. In the three-channel configuration illustrated in FIG. 8, based on changes of polarization characteristic of illumination light due to presence of stress type of defects such as inclusions, such defects in the substrate may be further accurately detected by use in combination of a polarizer disposed between the patterned or structured substrate and the light source and a polarization analyzer disposed between the substrate and the imaging component.

The three-channel configuration illustrated in FIG. 8 is different from that illustrated in FIG. 5 in that to the illumination module 140 added are an illumination component for polarization detection 741 disposed below the substrate 120 and aligned with the imaging component 161 via a beam splitter 770, a first polarization component 730 (hereinafter also referred as to polarizer 730) disposed between the substrate 120 and the illumination component for polarization detection 741, and a second polarization component 750 (hereinafter also referred as to a polarization analyzer 750) disposed between the substrate 120 and the imaging component 161. In the configuration illustrated in FIG. 8, the illumination component for polarization detection 741 shares with the diffusive illumination component 141 and the collimated illumination component 441 a set of imaging components, i.e. the four imaging components 161-1, 161-2, 161-3 and 161-4. Hereinafter, a polarization detection channel constructed by the polarizer 730, the second polarization component 750, the illumination component for polarization detection 741 and the above four imaging components is also referred as to a third channel or a third detection channel. In FIG. 8, like reference signs denote like elements with those in FIGS. 3 and 5.

As illustrated in FIG. 8, the illumination component for polarization detection 741 comprises a third light source 742. Since the third detection channel of the present embodiment performs detection based on changes of polarization characteristic of detection light due to the presence of defects, measurement results is non-sensitive to the illumination mode, spectral range, illumination intensity or illumination angle of the third light source 742. Therefore, the third light source 742 may be diffusive source, collimated source or other sources where the illumination angle is not limited specifically; the third light source 742 may be monochromatic light sources, polychromatic light sources even or white light sources as long as its spectral range is within operation range of the image sensor 162; the third light source 742 may be semiconductor light source such as LED and laser, and even fluorescent and halogen light when the third detection channel operates alone (i.e. the first and second detection channels are not present or do not work during the detection of the substrate); and the third light source 742 may be located at any distance in the Y direction as shown in FIG. 3 from the substrate, unlike the first light source 142 which is required to be disposed as close as possible to the substrate 120, as long as the third light source 742 is capable of illuminating the region to be detected of the substrate so as to facilitate subsequent processing.

Although the illumination component for polarization detection 741 illustrated in FIG. 8 only comprises the third light source 742, the illumination component 741 may also comprise a diffuser (for example, when a diffusive illumination is required), illuminated optical components such as one or more lens (for example, when a collimated illumination is required), and so on.

As illustrated in FIG. 8, the beam splitter 770 is used so that the illumination component for polarization detection 741 and the diffusive illumination component 141 can share the imaging component 161. Note that the beam splitter 770 may be eliminated when a matrix photo-sensor or a time delay integration based photo-sensor, by placing the illumination component for polarization detection 741 so as to be spaced to the diffusive illumination component 141 of the first detection channel in the transferring direction (i.e. Z direction) of the substrate 120 and parallel to the diffusive illumination component 141 in the X direction orthogonal to the Z direction as shown in FIG. 3. With respect to this case, in the practice, due to limited reception range of the imaging component 161, the distance between the two illumination components 141 and 741 is substantially small. In addition, similar to the first detection channel, instead of using a single long light source as the third light source, a plurality of parallel short light sources spaced in the Z direction may be used in the polarization detection channel. Note that when a plurality of light sub-sources is used, a corresponding number of first and second polarization components should be used.

In the present embodiment, unlike the embodiments shown in FIGS. 3 and 5, the light emit by the first light source 142 is transmit through the beam splitter 770 and then illuminated on the substrate 120. The light emit by the third light source 742 becomes a linear-polarization light having a first polarization direction after transmission through the polarizer 730, the first polarization direction of the linear-polarization light is also the polarization direction of the polarizer 730. The linear-polarization light is reflected by the beam splitter 770 and illuminated on the substrate 120. The linear-polarization light is transmitted through the substrate 120, passed through the polarization analyzer 750 disposed above the substrate 120 and sensed by the imaging component 161. The polarization direction (hereinafter referred as to a second polarization direction) of the polarization analyzer 750 is set as to be orthogonal to that of the polarizer 730. As described above, in the orthogonal polarization configuration, the linear-polarization light transmit through areas with no stress type of defects of the substrate behaves in a total extinction manner after transmission through the polarization analyzer 750, and forms black region in the image obtained by the imaging component 161; while the linear-polarization light transmit through areas having stress type of defects behaves not in a total extinction manner after transmission through the polarization analyzer 750, and forms bright region in the image obtained by the imaging component 161. The present inventors find from the experiments that the distances between the first polarization component 730 and the substrate 120 and between the second polarization component 750 and the substrate 120 are of small and negligible influence on the measurement results. In other words, the first and second polarization components 730 and 750 may be located at any distance from the substrate 120, illumination component 741 and imaging component 161 as required. Also, when the first channel operates, the presence of the second polarization component 750 will decrease the light intensity of the first light source 142 in the diffusive illumination component 141 sensed by the imaging component 161, but will not destroy uniform light field of the detection light. Although a transmissive polarizer is used as the first and second polarization components in the present embodiment illustrated in FIG. 8, other kinds of polarization components capable of achieving polarization light are also possible, such as reflective polarizer, dichroic polarizer, birefringent crystal or the like.

In the present embodiment, the three illumination components, i.e., the collimated illumination component 441, the diffusive illumination component 141 and the illumination component for polarization detection 741, are not switched on simultaneously, but used to illuminate the substrate 120 alternately. The four imaging components 161-1, 161-2, 161-3 and 161-4 work when the collimated illumination component 441 switches on, when the diffusive illumination component 141 switches on, or when the illumination component for polarization detection 741 switches on. Therefore, the operation of the defect detection system of the three-channel configuration in FIG. 8 may proceed in the following manner, using the controlling module 190 to control work timing of each of the collimated illumination component 441, the diffusive illumination component 141, the illumination component for polarization detection 741 and the four imaging components 161-1, 161-2, 161-3 and 161-4. As the substrate 120 is moved past the illumination module 140 and the imaging module 160, the first light source 142 of the diffusive illumination component 141 is switched on, while the four imaging components 161-1, 161-2, 161-3 and 161-4 begin to capture light transmit through the substrate 120, thereby performing the first channel detection. Next, the first light source 142 of the diffusive illumination component 141 is switched off, and the second light source 442 of the collimated illumination component 441 is switched on while the four imaging components 161-1, 161-2, 161-3 and 161-4 begin to capture light reflected from the substrate 120, thereby performing the second channel detection. Then, the third light source 742 of the illumination component for polarization detection 741 is switched on while the four imaging components 161-1, 161-2, 161-3 and 161-4 begin to capture light transmit through the substrate 120, thereby performing the third channel detection.

Specifically, the controlling module 190 is used to sense displacement of the substrate 120 and calculate a period over which the substrate 120 moves a certain displacement

$$Δ L = \frac{P}{M}$$

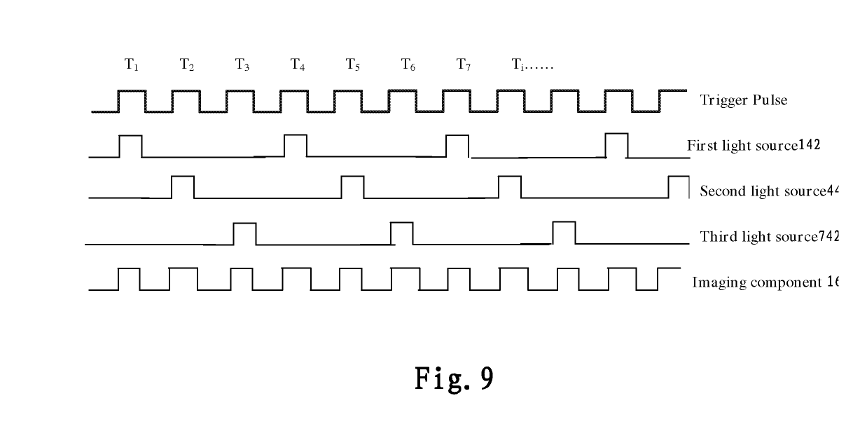

as a working period, where P denotes pixel width of image sensor in imaging component, and M denotes imaging magnification of the image sensor. All of channel detections should be performed once in one working period. The controlling module 190 then divides one working period into n equal or unequal parts based on number of groups n (n is a positive integral which is 3 or more) of detection channels which do not work simultaneously, resulting in trigger pulse sequence Tᵢ (i is a positive integral) shown in FIG. 9. Specifically, in three-channel configuration of the present embodiment, since the first channel detection, next the second channel detection and then the third channel detection are performed in one working period ΔT, one working period ΔT comprises three trigger pulses, such as T₁, T₂, and T₃. The controlling module 190 also controls operations of each of imaging components so as to scan the illuminated substrate when illumination from the light source is stable. It is noted that durations of n pulses included in one working period may be equal or unequal. For example, in order to improve signal-to-noise ratio of data obtained from reflection channels, the durations of reflection channels may be set to be longer than those of transmission channels.

Now controlling operation of the controlling module 190 with respect to each of light sources and imaging components is described referring to trigger pulse sequences shown in FIG. 9. During T₁ pulse period, after a certain delay of leading edge of pulse 1 generated by the controlling module 190, the first light source 142 switches on and illuminates the substrate 120 for a certain pulse width (which is less than a pulse period). The four image sensors 162-1, 162-2, 162-3, and 162-4 of the four imaging components 161-1, 161-2, 161-3 and 161-4 begin to work after the first light source 142 switches on. The first light source 142 then switches off before leading edge of pulse 2 comes while the four image sensors 162-1, 162-2, 162-3, and 162-4 are closed. During period of the first light source 142 being on, the second and third light sources 442 and 742 keep off, and the four imaging components 162 capture light transmit through the substrate 120 and send obtained data to the image processing module 180. The imaging processing module 180 then stores received data from each of the imaging sensors 162-1, 162-2, 162-3, and 162-4 in an array for respective imaging sensor in the buffer 182.

After a certain delay of leading edge of pulse 2, the second light source 442 switches on and illuminates the substance for a certain pulse width. The four image sensors 162 begin to work after the second light source 442 switches on. The second light source 442 then switches off before leading edge of pulse 3 comes while the four image sensors 162 are closed. During period of the second light source 442 being on, the first and third light sources 142 and 742 keep off, and the four imaging components 161 capture light reflected from the substrate 120, and send obtained data to the image processing module 180. The imaging processing module 180 then stores data received from each of the imaging sensors 162-1, 162-2, 162-3, and 162-4 in an array for respective imaging sensor in the buffer 182.

After a certain delay of leading edge of pulse 3, the third light source 742 switches on and illuminates the substrate 120 for a certain pulse width. The four image sensors 162 begin to work after the third light source 742 switches on. The third light source 742 then switches off before leading edge of pulse 4 comes while the four image sensors 162 are closed. During period of the third light source 742 being on, the first and second light sources 142 and 442 keep off, and the four imaging components 161 capture light transmit through the substrate 120, and send obtained data to the image processing module 180. The imaging processing module 180 then stores data received from each of the imaging sensors 162-1, 162-2, 162-3, and 162-4 in an array for respective imaging sensor in the buffer 182.

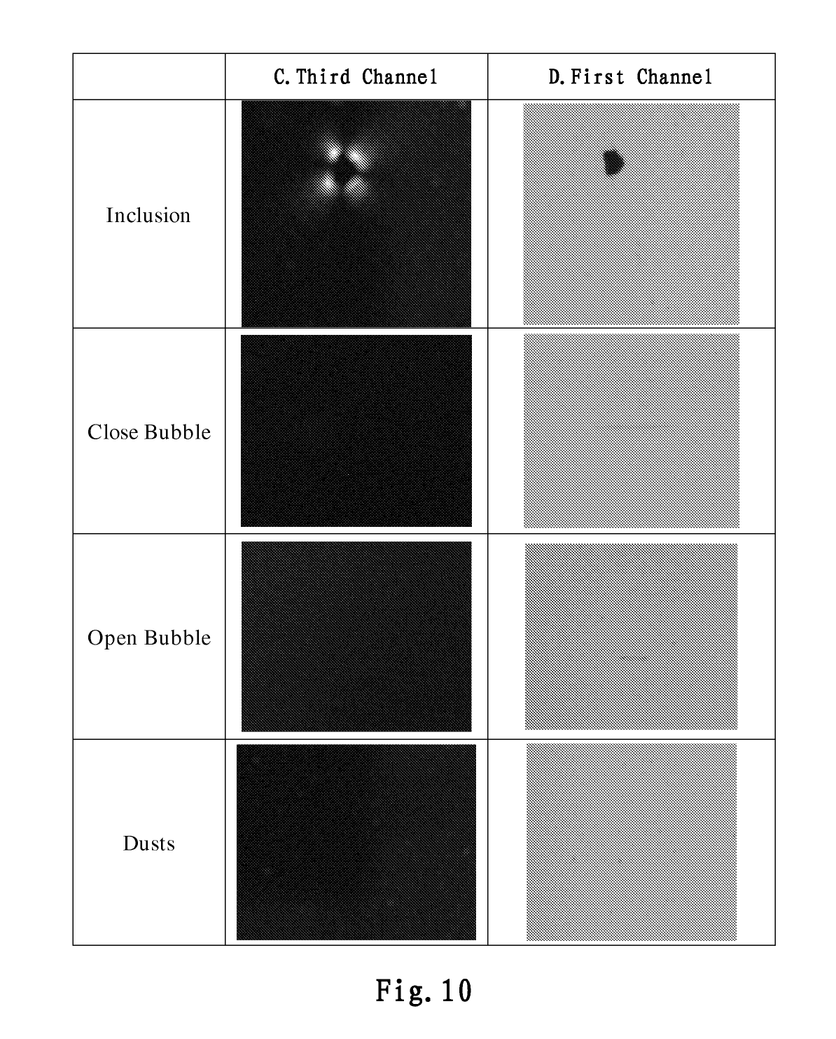

FIG. 10 illustrates detection results of inclusions, open bubbles, close bubbles and dusts of the solar photovoltaic patterned glass by three-channel optical configuration illustrated in FIG. 8, compared to results by the first detection channel. As shown in the column “C. Third Channel” in FIG. 10, the inclusions appear as bright areas in the black background, and open bubbles, close bubbles, or dusts are invisible. As shown in the column “D. First Channel” in FIG. 10, the inclusions appear as irregular dark region in a bright background; open bubbles or close bubbles appear as black regular elliptical shape, which can be distinguished by the second detection channel as shown in FIGS. 5 and 7; dusts appear as discrete spots of very small sizes in the image detected by the first detection channel and are not visible in the third detection channel or are bright areas in the black background. Based on features as to whether or not it is visible in the third detection channel (i.e. the polarization detection channel), the brightness and whether or not the image is distorted, the influence of the dusts on detection results may be eliminated, thereby performing a more accurate detection of the stress type of defects such as inclusions. Inclusions, open bubbles, close bubbles and other stress or optical-distortion type defects may be accurately distinguished by an integrated analysis of three channels illustrated in FIG. 8.

Although FIG. 8 illustrates an embodiment of integrated analysis of three channels, it should be understood that, depending on the type and nature of the substrate, two-channel configuration having the first channel (diffusive illumination detection channel) and the third channel (polarization channel) may be used, two-channel configuration having the second channel and the third channel may be used, or a single channel configuration having only polarization detection channel may be used in a case that only stress type of defects such as inclusions are intended to be detected. Also, although three channels share a set of imaging components as illustrated in FIG. 8 for the purpose of reducing cost, it should be understood by those skilled in the art that each detection channel may have a set of own imaging components. Or, any two of detection channels share a set of imaging components, for example, the polarization detection channel may share a set of imaging components only with the first channel (diffusive illumination detection channel) while the second channel (collimated illumination detection channel) uses a set of separate imaging components. Further, since the polarization detection channel places no limitation to the illumination mode of the third light source, the third channel may share a light source with the first channel, in which case the two channels sharing a light source will need two different sets of imaging components.

Those skilled in the art will understand that in the third detection channel, the illumination component 741 and the imaging component 161 are set at two sides of the substrate 120 respectively, and the imaging component 161 scans the substrate 120 by sensing the light emitted by the illumination component 741 and transmitted through the first polarization component 730, the substrate 120 and the second polarization component 750, but the present invention is not so limited. In other some embodiments of the present invention, the angle at which the illumination component emits light is set such that the imaging component 161 scans the substrate 120 by sensing the light that is derived from scattering through the substrate 120 of the light emitted by the illumination component 741 and transmitted through the first polarization component 730 and is then transmitted through the second polarization component 750.

Those skilled in the art will understand that in the third detection channel, the illumination component 741 and the imaging component 161 are set at two sides of the substrate 120 respectively, but the present invention is not so limited. In other some embodiments of the present invention, both of the illumination component 741 and the imaging component 161 are also set at one and the same side of the substrate 120. Under the condition that the illumination component 741 and the imaging component 161 are set at one and the same side of the substrate 120, the first polarization component 730 is set between the illumination component 741 and the substrate 120, the second polarization component 750 is set between the imaging component 161 and the substrate 120, and the imaging component 161 scans the substrate 120 by sensing the light that is derived from scattering through the substrate 120 of the light emitted by the illumination component 741 and transmitted through the first polarization component 730 and is then transmitted through the second polarization component 750.

The foregoing description of all aspects of the present invention is given for the purpose of illustration and explanation. It is not intended to exhaustively describe or limit the present invention to the disclosed precise forms, while many variations and changes are apparent. For example, in defect detection system of the present invention, number of detection channel is not limited to three, number of imaging components is not limited to four, and more than two light sources may be used. Further, although the polarization detection configuration is described with respect to the inclusions by way of example, those skilled in the art will understand based on the principle of the polarization detection that the above detection configuration of the present invention may also be used to detect other stress type or optical-distortion type of defects than inclusions. Therefore, it should be comprehended that the present invention is not limited to the disclosed specific embodiments but is intended to cover all possible modifications and variations defined by the appending claims.

1. A system for detecting a defect of a transparent or semi-transparent substrate, comprising:
a first illumination component, disposed at one side of the substrate and adapted to emit a diffusive light to the substrate;
a first imaging component, disposed at opposite side of the substrate and adapted to scan the substrate by sensing light emitted by the first illumination component and transmitted through the substrate, the first illumination component and the first imaging component constructing a first detection channel; and
a transport module, adapted to produce relative motion between the substrate, and the first illumination component and the first imaging component.

2. The system according to claim 1, wherein the first illumination component is disposed relative to the substrate in a way of providing substantially uniform illumination of the substrate.

3. The system according to claim 1, further comprising:
a second illumination component, disposed at the one side or the opposite side of the substrate and adapted to emit a light to the substrate; and
a second imaging component, disposed at the opposite side of the substrate and adapted to scan the substrate by sensing light derived from scattering through the substrate of the light emitted by the second illumination component, wherein
the transport module is further adapted to produce relative motion between the substrate, and the second illumination component and the second imaging component, and
the second illumination component and the second imaging component construct a second detection channel.

4. The system according to claim 3, further comprising:
a controlling module, adapted to control operations of the first illumination component, the second illumination component, the first imaging component and the second imaging component, so that the first illumination component and the second illumination component are not switched on simultaneously, the first imaging component scans the substrate when the first illumination component emits the diffusive light to the substrate, and the second imaging component scans the substrate when the second illumination component emits the light to the substrate.

5. The system according to claim 3, wherein
the first imaging component and the second imaging component are one and the same imaging component.

6. The system according to claim 3, wherein
the second illumination component is a collimated illumination component or an illumination component with a radiation angle.

7. The system according to claim 1, further comprising:
a third illumination component, adapted to emit a light to the substrate;
a third imaging component, disposed at the opposite side of the substrate and adapted to scan the substrate when the third illumination component emits the light to the substrate;
a first polarization component, having a first polarization direction and arranged between the third illumination component and the substrate; and
a second polarization component, having a second polarization direction orthogonal to the first polarization direction and arranged between the third imaging component and the substrate, wherein
the transport module is further adapted to produce relative motion between the substrate, and the third illumination component, the first polarization component, the second polarization component and the third imaging component, and
the third illumination component, the first polarization component, the second polarization component and the third imaging component construct a third detection channel.

8. The system according to claim 7, wherein
the third illumination component is arranged at the one side of the substrate, and
the third imaging component is further adapted to scan the substrate by sensing light emitted by the third illumination component and transmitted through the first polarization component, the substrate and the second polarization component or by sensing light that is derived from scattering through the substrate of the light emitted by the second illumination component and transmitted through the first polarization component and is then transmitted through the second polarization component.

9. The system according to claim 7, wherein
the third illumination component is arranged at the opposite side of the substrate, and
the third imaging component is further adapted to scan the substrate by sensing light that is derived from scattering through the substrate of the light emitted by the third illumination component and transmitted through the first polarization component and is then transmitted through the second polarization component.

10. The system according to claim 7, further comprising:
a controlling module, adapted to control operations of the first illumination component, the third illumination component, the first imaging component and the third imaging component, so that the first illumination component and the third illumination component are not switched on simultaneously, the first imaging component scans the substrate when the first illumination component emits the diffusive light to the substrate, and the third imaging component scans the substrate when the third illumination component emits the light to the substrate.

11. The system according to claim 7, wherein
the first imaging component and the third imaging component are one and the same imaging component.

12. The system according to claim 8, wherein
the first illumination component and the third illumination component are one and the same illumination component.

13. The system according to claim 3, further comprising:
a third illumination component, adapted to emit a light to the substrate;
a third imaging component, disposed at the opposite side of the substrate and adapted to scan the substrate when the third illumination component emits the light to the substrate;
a first polarization component, having a first polarization direction and arranged between the third illumination component and the substrate; and
a second polarization component, having a second polarization direction orthogonal to the first polarization direction and arranged between the third imaging component and the substrate, wherein
the transport module is further adapted to produce relative motion between the substrate, and the third illumination component, the first polarization component, the second polarization component and the third imaging component, and
the third illumination component, the first polarization component, the second polarization component and the third imaging component construct a third detection channel.

14. The system according to claim 13, wherein
the third illumination component is arranged at the one side of the substrate, and
the third imaging component is further adapted to scan the substrate by sensing light emitted by the third illumination component and transmitted through the first polarization component, the substrate and the second polarization component or by sensing light that is derived from scattering through the substrate of the light emitted by the second illumination component and transmitted through the first polarization component and is then transmitted through the second polarization component.

15. The system according to claim 13, wherein
the third illumination component is arranged at the opposite side of the substrate, and
the third imaging component is further adapted to scan the substrate by sensing light that is derived from scattering through the substrate of the light emitted by the second illumination component and transmitted through the first polarization component and is then transmitted through the second polarization component.

16. The system according to claim 13, further comprising:
a controlling module, adapted to control operations of the first illumination component, the second illumination component, the third illumination component, the first imaging component, the second imaging component and the third imaging component, so that the first illumination component, the second illumination component and the third illumination component are not switched on simultaneously, the first imaging component scans the substrate when the first illumination component emits the diffusive light to the substrate, the second imaging component scans the substrate when the second illumination component emits the light to the substrate and the third imaging component scans the substrate when the third illumination component emits the light to the substrate.

17. The system according to claim 13, wherein
all or any two of the first imaging component, the second imaging component and the third imaging component are one and the same imaging component.

18. The system according to claim 14, wherein
the first illumination component and the third illumination component are one and the same illumination component.

19. The system according to claim 1, further comprising:
an image processing module, adapted to process data from the first imaging component, to detect and classify the defect of the substrate.

20. The system according to claim 1, wherein
the substrate includes a kind of patterned or structured substrate used in a photovoltaic cell or a photovoltaic module, the pattern or structure including pyramid shape.

21. The system according to claim 1, wherein the number of the first imaging component is determined depending on width of the substrate, imaging numerical aperture, detection precision, as well as estimated maximum number or minimum detection size of defects of the substrate.

22. A system for detecting a defect of a transparent or semi-transparent substrate, comprising:
a second illumination component, disposed at one side of the substrate or opposite side of the substrate and adapted to emit a light to the substrate;
a second imaging component, disposed at the opposite side of the substrate and adapted to scan the substrate by sensing light derived from scattering through the substrate of the light emitted by the second illumination component; and
a transport module, adapted to produce relative motion between the substrate, and the second illumination component and the second imaging component, wherein
the second illumination component and the second imaging component construct a second detection channel.

23. The system according to claim 22, wherein
the second illumination component is a collimated illumination component or an illumination component with a radiation angle.

24. The system according to claim 22, further comprising:
a third illumination component, adapted to emit a light to the substrate;
a third imaging component, disposed at the opposite side of the substrate and adapted to scan the substrate when the third illumination component emits the light to the substrate;
a first polarization component, having a first polarization direction and arranged between the third illumination component and the substrate; and
a second polarization component, having a second polarization direction orthogonal to the first polarization direction and arranged between the third imaging component and the substrate, wherein
the transport module is further adapted to produce relative motion between the substrate, and the third illumination component, the first polarization component, the second polarization component and the third imaging component, and
the third illumination component, the first polarization component, the second polarization component and the third imaging component construct a third detection channel

25. The system according to claim 24, wherein
the third illumination component is arranged at the one side of the substrate, and
the third imaging component is further adapted to scan the substrate by sensing light emitted by the third illumination component and transmitted through the first polarization component, the substrate and the second polarization component or by sensing light that is derived from scattering through the substrate of the light emitted by the second illumination component and transmitted through the first polarization component and is then transmitted through the second polarization component.

26. The system according to claim 24, wherein
the third illumination component is arranged at the opposite side of the substrate, and
the third imaging component is further adapted to scan the substrate by sensing light that is derived from scattering through the substrate of the light emitted by the third illumination component and transmitted through the first polarization component and is then transmitted through the second polarization component.

27. The system according to claim 24, further comprising:
a controlling module, adapted to control operations of the second illumination component, the third illumination component, the second imaging component and the third imaging component, so that the second illumination component and the third illumination component are not switched on simultaneously, the second imaging component scans the substrate when the second illumination component emits the light to the substrate and the third imaging component scans the substrate when the third illumination component emits the light to the substrate.

28. The system according to claim 24, wherein
the second imaging component and the third imaging component are one and the same imaging component.

29. The system according to claim 25, wherein
the second illumination component and the third illumination component are one and the same illumination component, when the second illumination component is arranged at the one side of the substrate.

30. The system according to claim 22, further comprising:
an image processing module, adapted to process data from the second imaging component, to detect and classify the defect of the substrate.

31. A system for detecting a defect of a transparent or semi-transparent substrate, comprising:
a third illumination component, adapted to emit a light to the substrate;
a third imaging component, disposed at one side of the substrate and adapted to scan the substrate when the third illumination component emits the light to the substrate;
a first polarization component, having a first polarization direction and arranged between the third illumination component and the substrate;
a second polarization component, having a second polarization direction orthogonal to the first polarization direction and arranged between the third imaging component and the substrate; and
a transport module, adapted to produce relative motion between the substrate, and the third illumination component, the first polarization component, the second polarization component and the third imaging component, wherein
the third illumination component, the first polarization component, the second polarization component and the third imaging component construct a third detection channel.

32. The system according to claim 31, wherein
the third illumination component is arranged at opposite side of the substrate, and
the third imaging component is further adapted to scan the substrate by sensing light emitted by the third illumination component and transmitted through the first polarization component, the substrate and the second polarization component or by sensing light that is derived from scattering through the substrate of the light emitted by the second illumination component and transmitted through the first polarization component and is then transmitted through the second polarization component.

33. The system according to claim 31, wherein
the third illumination component is arranged at the one side of the substrate, and
the third imaging component is further adapted to scan the substrate by sensing light that is derived from scattering through the substrate of the light emitted by the third illumination component and transmitted through the first polarization component and is then transmitted through the second polarization component.

34. The system according to claim 31, further comprising:
an image processing module, adapted to process data from the third imaging component, to detect and classify the defect of the substrate.

35. The system according to claim 31, wherein the number of the third imaging component is determined depending on width of the substrate, imaging numerical aperture, detection precision, as well as estimated maximum number or minimum detection size of defects of the substrate.

36. A method for detecting a defect of a transparent or semi-transparent substrate, comprising:
using a first illumination component disposed at one side of the substrate to emit a diffusive light to the substrate;
using a first imaging component disposed at opposite side of the substrate to scan the substrate by sensing light emitted by the first illumination component and transmitted through the substrate, the first illumination component and the first imaging component constructing a first detection channel;
producing relative motion between the substrate, and the first illumination component and the first imaging component; and
processing data from the first imaging component, to detect and classify the defect of the substrate.

37. The method according to claim 36, further comprising:
using a second illumination component disposed at the one side or the opposite side of the substrate to emit a light to the substrate;
using a second imaging component disposed at the opposite side of the substrate and adapted to scan the substrate by sensing light derived from scattering through the substrate of the light emitted by the second illumination component;
producing relative motion between the substrate, and the second illumination component and the second imaging component; and
processing data from the first imaging component and the second imaging component, to detect and classify the defect of the substrate.

38. The method according to claim 36, further comprising:
using a third illumination component to emit a light to the substrate;
using a third imaging component disposed at the opposite side of the substrate to scan the substrate when the third illumination component emits the light to the substrate;
arranging a first polarization component having a first polarization direction between the third illumination component and the substrate;
arranging a second polarization component having a second polarization direction orthogonal to the first polarization direction between the third imaging component and the substrate;
producing relative motion between the substrate, and the third illumination component, the first polarization component, the second polarization component and the third imaging component; and
processing data from the first imaging component and the third imaging component, to detect and classify the defect of the substrate.

39. The method according to claim 37, further comprising:
using a third illumination component to emit a light to the substrate;
using a third imaging component disposed at the opposite side of the substrate to scan the substrate when the third illumination component emits the light to the substrate;
arranging a first polarization component having a first polarization direction between the third illumination component and the substrate;
arranging a second polarization component having a second polarization direction orthogonal to the first polarization direction between the third imaging component and the substrate;
producing relative motion between the substrate, and the third illumination component, the first polarization component, the second polarization component and the third imaging component; and
processing data from the first imaging component, the second imaging component and the third imaging component, to detect and classify the defect of the substrate.

40. A method for detecting a defect of a transparent or semi-transparent substrate, comprising:
using a second illumination component disposed at one side or opposite side of the substrate to emit a light to the substrate;
using a second imaging component disposed at the opposite side of the substrate and adapted to scan the substrate by sensing light derived from scattering through the substrate of the light emitted by the second illumination component;
producing relative motion between the substrate, and the second illumination component and the second imaging component; and
processing data from the second imaging component, to detect and classify the defect of the substrate.

41. The method according to claim 40, further comprising:
using a third illumination component to emit a light to the substrate;
using a third imaging component disposed at the opposite side of the substrate to scan the substrate when the third illumination component emits the light to the substrate;
arranging a first polarization component having a first polarization direction between the third illumination component and the substrate;
arranging, a second polarization component having a second polarization direction orthogonal to the first polarization direction between the third imaging component and the substrate;
producing relative motion between the substrate, and the third illumination component, the first polarization component, the second polarization component and the third imaging component; and
processing data from the second imaging component and the third imaging component, to detect and classify the defect of the substrate.

42. A method for detecting a defect of a transparent or semi-transparent substrate, comprising:
using a third illumination component to emit a light to the substrate;
using a third imaging component disposed at one side of the substrate to scan the substrate when the third illumination component emits the light to the substrate;
arranging a first polarization component having a first polarization direction between the third illumination component and the substrate;
arranging a second polarization component having a second polarization direction orthogonal to the first polarization direction between the third imaging component and the substrate;
producing relative motion between the substrate, and the third illumination component, the first polarization component, the second polarization component and the third imaging component; and
processing data from the third imaging component, to detect and classify the defect of the substrate.
